(19) United States
(12) Patent Application Publication
(10) Pub. No.: US 2009/0165257 A1
(43) Pub. Date: Jul. 2, 2009

(54) HANDLE FOR MEASURING WHEEL

(75) Inventor: Wen-Yuan Lin, Sansia Township (TW)

Correspondence Address: SCHMEISER, OLSEN & WATTS, 22 CENTURY HILL DRIVE, SUITE 302, LATHAM, NY, 12110, US

(73) Assignee: YOUTH TOY ENTERPRISE CO., LTD., Sansia Township (TW)

(21) Appl. No.: 11/967,444

(22) Filed: Dec. 31, 2007

(51) Int. Cl. B25G 1/04

(52) U.S. Cl. 16/429

(57) ABSTRACT

A handle for measuring wheel includes a supporting section having a wheel support provided at a lower end thereof; a telescoping section movably connected to a first side of the supporting section, and having a plurality of longitudinally spaced locating holes; a locating unit provided on the supporting section at a predetermined position thereof, and including an elastic portion attached to an opposite second side of the supporting section, a pull tab outward extended from an outer side of the elastic portion, and a stopper located opposite to the pull tab to normally releasably engage with one of the locating holes on the telescoping section; and a wheel rotatably mounted to the wheel support. When the pull tab is pulled to disengage the stopper from the locating hole, the telescoping section may be freely slid to a desired height relative to the supporting section.

### FIELD OF THE INVENTION

The present invention relates to a handle for measuring wheel, and more particularly to a length-adjustable handle for measuring wheel having a telescoping section that may be easily adjusted in height relative to a supporting section via control of a locating unit.

### BACKGROUND OF THE INVENTION

FIGS. 1 to 3 shows a conventional measuring wheel 5, which includes a supporting section 51, a telescoping section 52, a fastening element 53, and a wheel 54. The supporting section 51 is internally provided with a sliding bush 511, and has a plurality of through holes 512 longitudinally spaced thereon. The telescoping section 52 is movably set in the sliding bush 511 of the supporting section 51, and provided near a lower free end with a locating hole 521. The fastening element 53 may be extended through one of the through holes 512 and the locating hole 521 to thereby fixedly connect the supporting section 51 and the telescoping section 52 to each other. The wheel 54 is rotatably connected to a lower end of the supporting section 51. A user may grip at the telescoping section 52 with the wheel 54 in contact with the ground. The user may push the wheel 54 to rotate while walking, so as to achieve the purpose of measuring a distance. The user may dismount the fastening element 53 to slide the telescoping section 52 in the sliding bush 511 to a desired height relative to the supporting section 51, and then remounts the fastening element 53 by extending it through the locating hole 521 on the telescoping section 52 and a corresponding through hole 512 on the supporting section 51 to hold the telescoping section 52 to the desired height.

While the above-structured measuring wheel 5 provides the function of measuring a distance and has a length-adjustable telescoping section 52, the adjustment of the length of the telescoping section is troublesome. To adjust the telescoping section, the user has to dismount the fastening element 53, and remounts the same when the locating hole 521 on the telescoping section 52 has been aligned with a desired through hole 512 on the supporting section 51. Moreover, since the supporting section 51 and the telescoping section 52 have a predetermined length each, it is uneasy to exactly align the locating hole 521 with the desired through hole 512 for the user to quickly extend the fastening element 53 through the two holes. And, the telescoping section 52 might be separated from the sliding bush 511 in the supporting section 51 when the user applies an excessive force during the adjustment. Therefore, the handle for the conventional measuring wheel 5 is not convenient for use.

### SUMMARY OF THE INVENTION

A primary object of the present invention is to provide a handle for measuring wheel that is easily adjustable in length via control of a locating unit.

To achieve the above and other objects, the handle for measuring wheel according to the present invention includes a supporting section having a wheel support provided to a lower end thereof; a telescoping section being longitudinally movably connected to a first lateral side of the supporting section, and having a plurality of locating holes longitudinally spaced thereon; a locating unit being provided on the supporting section at a predetermined position thereof, and including an elastic portion attached to a second lateral side of the supporting section opposite to the first lateral side, a pull tab connected to and outward extended from one side of the elastic portion, and a stopper located at the other side of the elastic portion opposite to the pull tab to normally releasably engage with one of the locating holes on the telescoping section; and a wheel rotatably mounted to the wheel support at the lower end of the supporting section. When the pull tab is pulled to disengage the stopper from the locating hole, the telescoping section may be freely slid to a desired height relative to the supporting section.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a conventional measuring wheel;

FIG. 2 is an assembled view of FIG. 1;

FIG. 3 is a sectional view taken along line A-A of FIG. 2;

FIG. 4 is an exploded perspective view showing a measuring wheel with a handle according to a preferred embodiment of the present invention;

FIG. 5 is an assembled view of FIG. 4;

FIG. 6 is a sectional view taken along line B-B of FIG. 5; and

FIG. 7 is a sectional view taken along line C-C of FIG. 6.

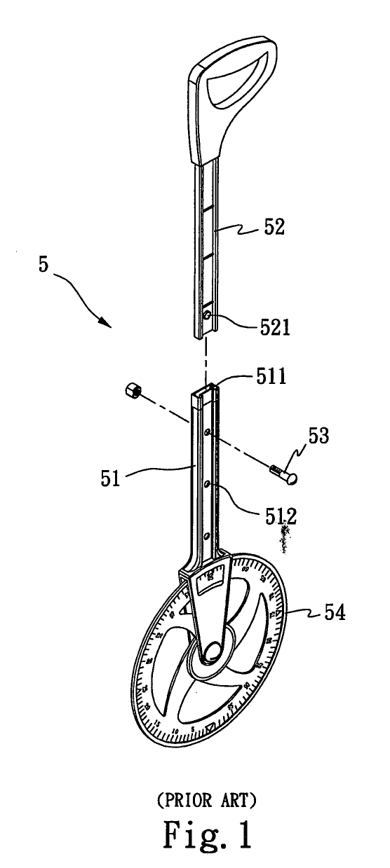

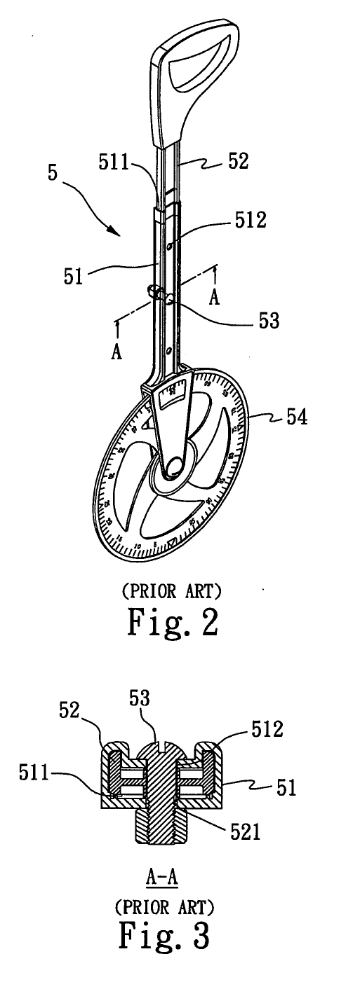

### DETAILED DESCRIPTION OF THE PREFERRED EMBODIMENTS

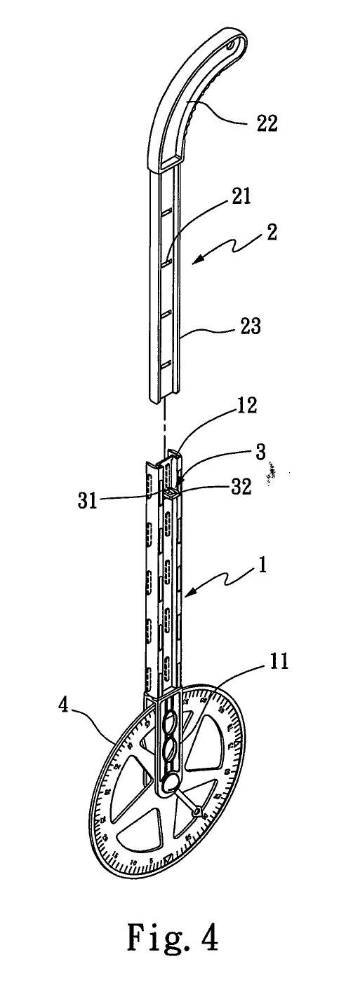

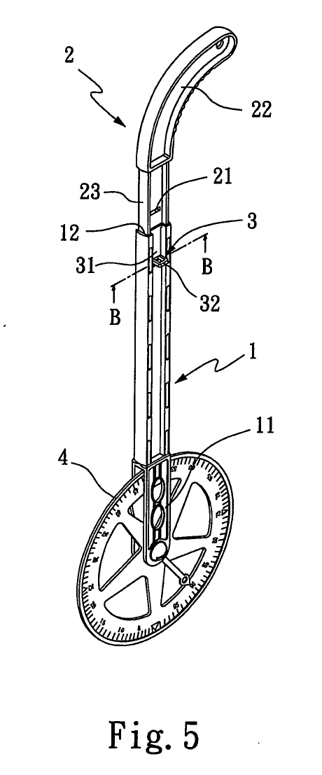

Please refer to FIGS. 4 and 5 that are exploded and assembled perspective views, respectively, showing a measuring wheel with a handle according to a preferred embodiment of the present invention. As shown, the handle for measuring wheel according to the present invention includes a supporting section 1, a telescoping section 2, a locating unit 3, and a wheel 4.

The supporting section 1 is provided at a lower end with a wheel support 11, and at two opposite longitudinal edges of a first lateral side with a slide channel 12 each.

The telescoping section 2 is provided with a plurality of longitudinally spaced locating holes 21, and has a grip 22 mounted to an upper end thereof. The telescoping section 2 is formed at two longitudinal edges with a guide rail 23 each, so that the telescoping section 2 is connected to the first lateral side of the supporting section 1 with the two guide rails 23 separately slidably received in the two slide channels 12 on the supporting section 1.

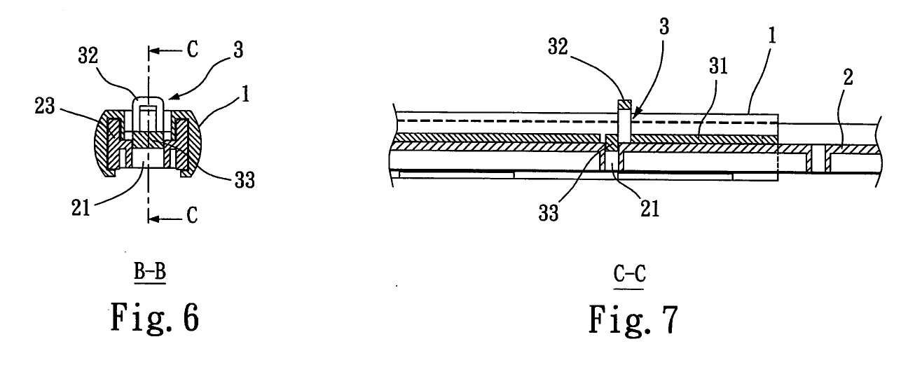

Please also refer to FIG. 6 that is a sectional view taken along line B-B of FIG. 5 and to FIG. 7 that is a sectional view taken along line C-C of FIG. 6. The locating unit 3 is mounted to a predetermined position on the supporting section 1, and includes an elastic portion 31 attached to a second lateral side of the supporting section 1 opposite to the first lateral side, a pull tab 32 connected to and outward extended from an outer side of the elastic portion 31, and a stopper 32 located at another side of the elastic portion 31 opposite to the pull tab 32 to normally releasably engage with one of the locating holes 21 on the telescoping section 2.

The wheel 4 is rotatably mounted to the wheel support 11 at the lower end of the supporting section 1.

To use the measuring wheel, a user may hold the telescoping section 2 at the grip 22 with the wheel 4 mounted on the wheel support 11 of the supporting section 1 in contact with the ground or a work surface to be measured, and walks while rolling the wheel 4 to measure a distance.

Since different users have different heights and hand lengths, as well as different handling manners, the handle of the measuring wheel may be adjusted in its overall length to satisfy different users by upward or downward sliding the telescoping section 2 to a preferred height or length relative to the supporting section 1. To adjust the overall length of the measuring wheel handle, a user may directly pull the pull tab 32 of the locating unit 3. An elasticity of the elastic portion 31 allows the pull tab 32 to displace outward relative to the second lateral side of the supporting section 1 and thereby brings the stopper 33 to disengage from the locating hole 21 on the telescoping section 2. At this point, the user may pull or push the telescoping section 2 for the two guide rails 23 of the telescoping section 2 to slide in and along the two slide channels 12 of the supporting section 1, so that the telescoping section 2 is adjustable to a desired height relative to the supporting section 1. When the telescoping section 2 has been adjusted to the desired height, the pull tab 32 is released. With the elasticity of the elastic portion 31, the pull tab 32 is automatically moved inward for the stopper 33 to engage with a new locating hole 21 on the telescoping section 2, so that the telescoping section 2 is held to the desired height relative to the supporting section 1.

With the above arrangements, the handle of a measuring wheel may be easily adjusted to a desired overall length, allowing a user to manipulate the measuring wheel in a more comfortable, smooth, and efficient manner. Therefore, the present invention is improved and more practical for use.

What is claimed is:

1. A handle for measuring wheel, comprising:
a supporting section having a wheel support provided to a lower end thereof;
a telescoping section being longitudinally movably connected to a first lateral side of the supporting section, and having a plurality of locating holes longitudinally spaced thereon;
a locating unit being provided on the supporting section at a predetermined position thereof, and including an elastic portion attached to a second lateral side of the supporting section opposite to the first lateral side, a pull tab connected to and outward extended from an outer side of the elastic portion, and a stopper located at another side of the elastic portion opposite to the pull tab to normally releasably engage with one of the locating holes on the telescoping section; and
a wheel mounted to the wheel support at the lower end of the supporting section.

2. The handle for measuring wheel as claimed in claim 1, wherein the supporting section is provided along two opposite longitudinal edges of the first lateral side with a slide channel each.

3. The handle for measuring wheel as claimed in claim 1, wherein the telescoping section has a grip mounted to an upper end thereof.

4. The handle for measuring wheel as claimed in claim 1, wherein the telescoping section is provided along two longitudinal edges with a guide rail each.
